(19) United States
(12) Patent Application Publication
(10) Pub. No.: US 2014/0008919 A1
(43) Pub. Date: Jan. 9, 2014

(54) SECURING MEANS FOR A BARRIER AND METHOD OF USE THEREOF

(71) Applicant: Team Excel Development Ltd., Shanghai (CN)

(72) Inventor: Tyler Huang, Shanghai (CN)

(21) Appl. No.: 13/934,649

(22) Filed: Jul. 3, 2013

(30) Foreign Application Priority Data
Jul. 4, 2012 (GB) 1211885.7

(51) Int. Cl. E05C 1/06

(52) U.S. Cl. CPC E05C 1/06
USPC 292/37

(57) ABSTRACT

A securing means for use on a barrier such as a child safety barrier and/or the like where the securing means includes a housing, stopper means that are movable relative to said housing between an extended position, wherein the stopper means protrude outwardly from said housing to allow engagement of the stopper means with a suitable surface in use, and a retracted position, wherein the stopper means is in a retracted position with respect to said housing relative to said extended position to allow disengagement of the stopper means from a suitable surface in use. The securing means includes cam means and movement of said cam means results in movement of said stopper means between said extended and retracted positions.

This invention relates to securing means for a barrier and to a method of use thereof.

Although the following description refers almost exclusively to securing means for a child safety barrier, and particularly to a foldable child safety barrier, it will be appreciated by persons skilled in the art that the barrier means of the present invention can be used on any barrier, guard and/or gate, whether foldable or non-foldable, for any suitable purpose.

Child safety gates are normally fitted in an opening between two opposing wall surfaces to prevent access by a child or small animal from one locality to another locality without first opening and/or removing the gate. Child safety gates can be hingedly mounted, directly or indirectly, to one of the wall surfaces to allow movement of the gate between open and closed positions with respect to the opposite wall surface. Alternatively, or in addition, the child safety gate can be held in position with respect to one or more of the wall surfaces using one or more pressure pads or stoppers to apply an engaging force against the wall surfaces.

One example of a child safety gate is disclosed in WO2004/079142. This gate uses a ferrule for engagement with one or more of the wall surfaces with which the gate is to be located with respect to in use. In one example, the ferrule can be rotatably mounted to a threaded rod which allows the position of the ferrule with respect to the gate to be adjusted to allow adjustment of the width of the gate in the opening in which is to be located in use. In another example, a clamping mechanism is provided including a handle element to move the ferrule into engagement with the wall surface.

It is an aim of the present invention to provide improved securing means suitable for use on a barrier.

It is a further aim of the present invention to provide a method of using securing means suitable for use on a barrier.

It is a yet further aim of the present invention to provide a barrier with securing means and/or a method of use thereof.

According to a first aspect of the present invention there is provided securing means for use on a barrier, said securing means including a housing, pressure or stopper means that are movable relative to said housing between an extended position, wherein the pressure/stopper means protrude outwardly from said housing to allow engagement of the stopper means with a suitable surface in use, and a retracted position, wherein the pressure/stopper means is in a retracted position with respect to said housing relative to said extended position to allow disengagement of the pressure/stopper means from a suitable surface in use, and wherein cam means are provided and movement of said cam means results in movement of said pressure/stopper means between said extended and retracted positions.

Thus, the securing means of the present invention uses a cam mechanism to apply a force against the pressure/stopper means sufficient to allow engagement of the pressure/stopper means against a suitable surface in which the barrier or other item is to be located with respect to or engaged with in use.

The pressure or stopper means (hereinafter referred to as stopper means for clarity purposes) can be rotatably, pivotably and/or slidably moved between the extended and retracted positions. In a preferred embodiment the stopper means are slidably moved between the extended and retracted positions in use.

Preferably the stopper means moves in a substantially horizontal direction, or in a direction substantially parallel to an upper frame member of the barrier on which the securing means may be mounted or associated with in one embodiment in use, when moving between the extended and retracted positions.

In one embodiment the stopper means has gripping means or a gripping surface provided on or associated therewith to allow the stopper means to grip with a surface in which it engages with in the extended position in use.

Preferably the gripping means or gripping surface is provided on an end surface or free end of the stopper means.

In one embodiment the stopper means is in the form of an arm member and further preferably an elongate arm member. The arm member or elongate arm member is movable relative to said housing between said extended and retracted positions.

In one embodiment the stopper means includes a stopper element and a stopper housing and the stopper element is movable relative to said stopper housing. Preferably this movement is independent to the movement of the stopper means as a result of movement of the cam means. For example, movement of the stopper element with respect to the stopper housing can allow a relatively fine adjustment of the position of the stopper element with respect to the housing of the securing means in use.

In one embodiment the stopper element is rotatably mounted to the stopper housing. For example, the rotatable mounting can include a complementary screw thread arrangement and/or the like.

Preferably the cam means are movably mounted in or on said housing.

The cam means can be rotatably, pivotably or slidably movable to allow movement of said stopper means between said extended and retracted positions. In a preferred embodiment the cam means are rotatably or pivotably mounted to or in said housing. Thus, in one example, rotation or pivoting of the cam means results in sliding movement of the stopper means between the retracted and extended positions.

Preferably user actuation means are provided on or associated with said housing and/or said cam means and movement or actuation of said user actuation means allows movement of the cam means in use.

In one embodiment the user actuation means includes handle means. A user moves said handle means to allow the cam means to be moved in such a manner to result in movement of the stopper means between the extended and retracted positions.

Preferably the user actuation means and/or handle means are provided on two or opposite sides of the housing to allow the same to be actuated from different sides of the housing and/or barrier on which the housing is mounted in use.

In one embodiment the cam means includes a cam surface which is moved between engaged and disengaged positions with respect to the stopper means in use. As the cam surface is moved from a disengaged position to an engaged position with respect to the stopper means, this moves the stopper means from the retracted position to the extended position. As the cam surface is moved from the engaged position to the disengaged position, this moves the stopper means from the extended position to the retracted position.

Preferably the stopper means includes a substantially flat or linear surface against which the cam means or cam surface moves in and out of engagement with in use.

In one embodiment locking means are provided to lock the cam means in the engaged and/or disengaged positions in use.

Preferably resilient biasing means are provided to bias the locking means to a locked position with respect to the cam means in use.

Preferably the locking means includes one or more user actuation portions to allow a user to actuate the locking means in use. Further preferably the one or more user actuation portions allow a user to move the locking means from a locked position to an unlocked position.

In one embodiment the user actuation portion of the locking means has to be actuated substantially simultaneously to actuation of the user actuation means associated with the cam means in use. Thus, a user is required to move the locking means to an unlocked position whilst moving the cam means.

In one embodiment the user actuation portion of the locking means is accessible from or provided on two or more sides or opposite sides of the housing to allow actuation of the locking means from two or more sides or opposite sides of the barrier on which the securing means is mounted in use.

Preferably the locking means and/or user actuation portion are slidably mounted with respect to the housing. For example, a user may be required to slidably depress the locking means and/or user actuation portion with respect to the housing to allow the locking means to be moved from a locked position to an unlocked position in use.

The resilient biasing means can include one or more springs, sprung material and/or the like.

Preferably resilient biasing means are associated with opposing surfaces of the locking means to allow the locking means to remain substantially central of the housing and/or cam means in use.

Preferably the locking means includes a locking member and the locking member is resiliently biased to an engaged position against the cam means to substantially prevent movement of the cam means when the locking means is in the locked position. Actuation of the user actuation portion typically moves the locking member to a disengaged position with respect to the cam means, thereby moving the locking means to an unlocked position.

In one embodiment the housing of the barrier securing means includes two or more parts that are joined together to form the housing.

In one embodiment gripping means are provided on or associated with the housing of the securing means to allow a user to easily grip the securing means in use.

In one embodiment the gripping means includes one or more recessed portions to allow a user to grip the same in use. The one or more recessed portions can also reduce the amount of material required to form the housing.

In one embodiment the securing means are provided with attachment means for allowing the securing means to be attached to a barrier in use. The attachment means can include any or any combination of one or more channels, apertures, recesses, nuts and bolts, brackets, screws, welding, adhesive, friction fit, clips, inter-engaging members and/or the like.

Preferably the securing means are provided or mounted on or to a barrier, such as a gate, child safety gate, guard and/or the like.

In one embodiment the barrier is of a foldable type movable between a substantially erect position and at least a partially folded or collapsed position.

In one embodiment the barrier includes a frame forming or provided with barrier means therewith. In one example the barrier means includes fabric or substantially flexible material that is provided between or over the frame to substantially prevent access through said frame (i.e. to prevent access from one side of the frame to an opposite side of the frame). The fabric or substantially flexible material can, in one embodiment, move with the barrier between the substantially erect and folded positions. In a further example, the barrier means can include one or more frame members, substantially rigid material and/or the like.

In one embodiment the frame includes at least two upright, lateral or substantially vertical frame members and at least two transverse or substantially horizontal frame members located between the two upright/vertical frame members.

Preferably the two transverse or substantially horizontal members form an upper barrier member and a lower barrier member of the barrier.

One or more of the frame members can be adjustable in their length using adjustment means to allow the size and/or dimensions of the frame and/or frame member to be adjusted. This allows the frame of the barrier to be fitted with respect to different sized openings and/or with respect to different arranged or spaced surfaces in use.

In one embodiment one or more of the frame members include two or more frame parts that are telescopically mounted to allow adjustment of the size or length of the one or more frame members in use.

Engagement means can be associated with the adjustment means of the one or more frame members to allow the frame members to be secured in a required length or size.

Preferably the securing means of the present invention are provided on or associated with one or more corners of the barrier to allow securing of the barrier in a required opening or between two or more required surfaces in use.

In one embodiment the securing means of the present invention are provided on at least two corners of the barrier and preferably these two corners are corners on the same side or edge of the barrier.

Preferably the securing means of the present invention are provided on upper and lower corners of the barrier.

In one embodiment one or more corners of the barrier are provided with pressure/stopper means. These stopper means can be substantially fixed or can be adjusted manually, such as by being rotatably movable to extended and retracted relative positions, but do not typically include the cam mechanism as described above.

According to a second aspect of the present invention there is provided a method of using securing means for a barrier.

According to further aspects of the present invention there is provided barrier securing means; a method of using barrier securing means; a barrier with securing means and a method of using a barrier with securing means.

An embodiment of the present invention will now be described with reference to the accompanying figures, wherein:

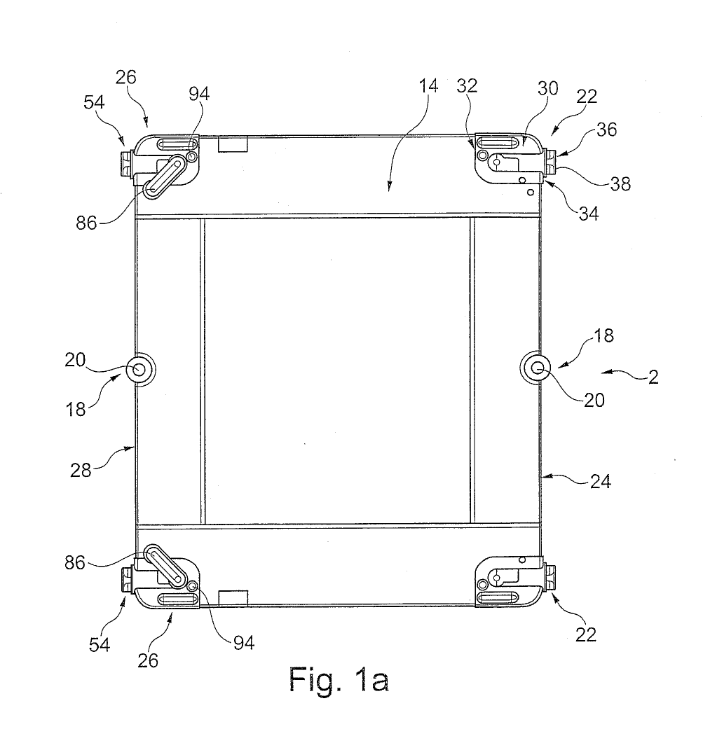

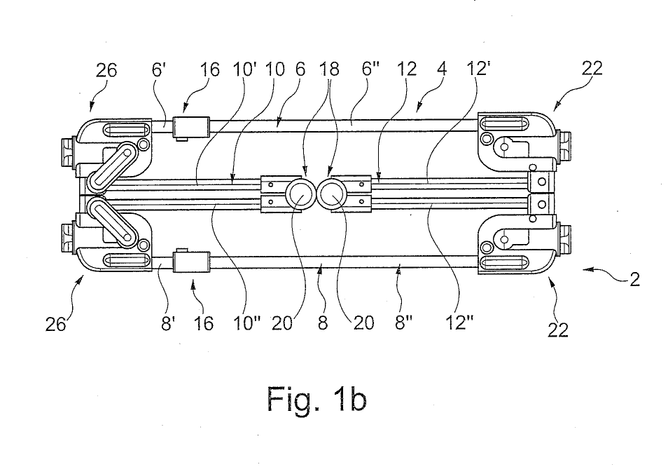

FIGS. 1a and 1b illustrates a child safety gate with securing means according to an embodiment of the present invention in a substantially erect position and a substantially folded position (with the barrier material removed) respectively;

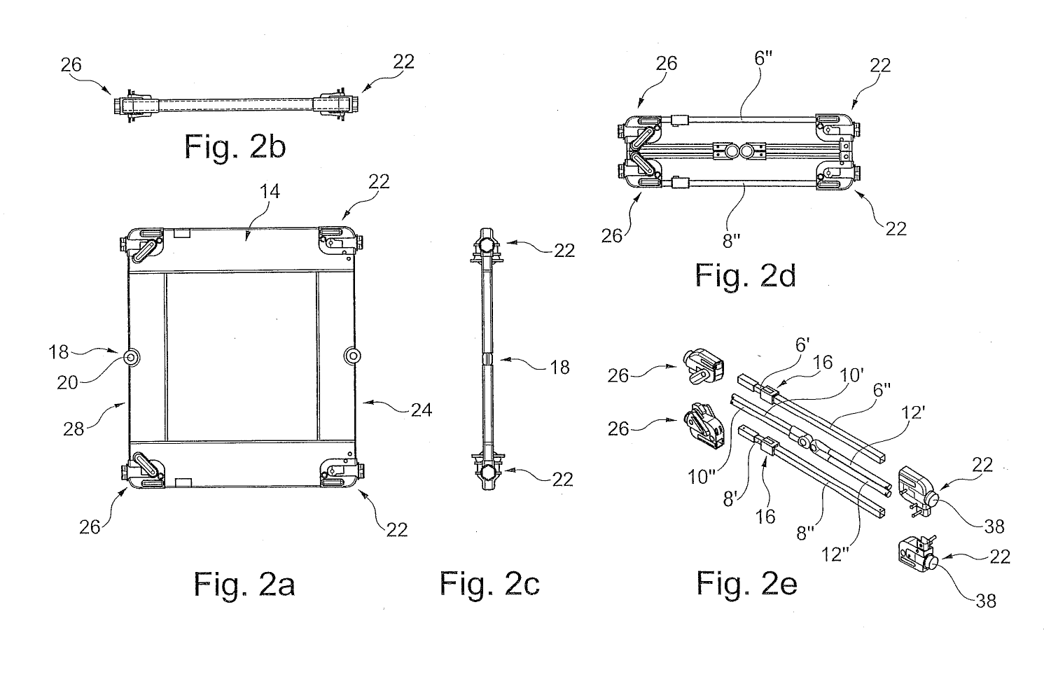

FIGS. 2a-2e illustrate the child safety gate in FIG. 1a from a front view, plan view from above, end view, folded view with the barrier material removed, and exploded folded view with the barrier material removed respectively;

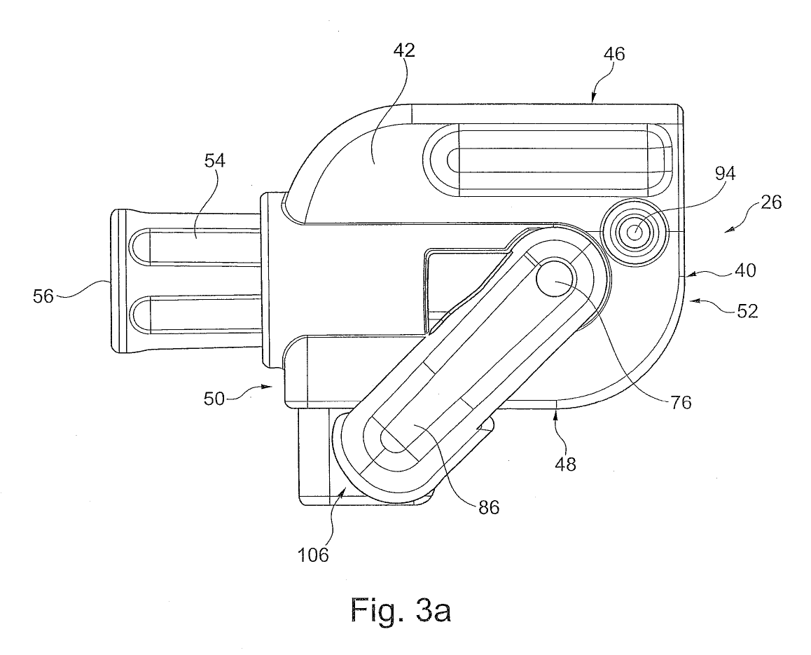

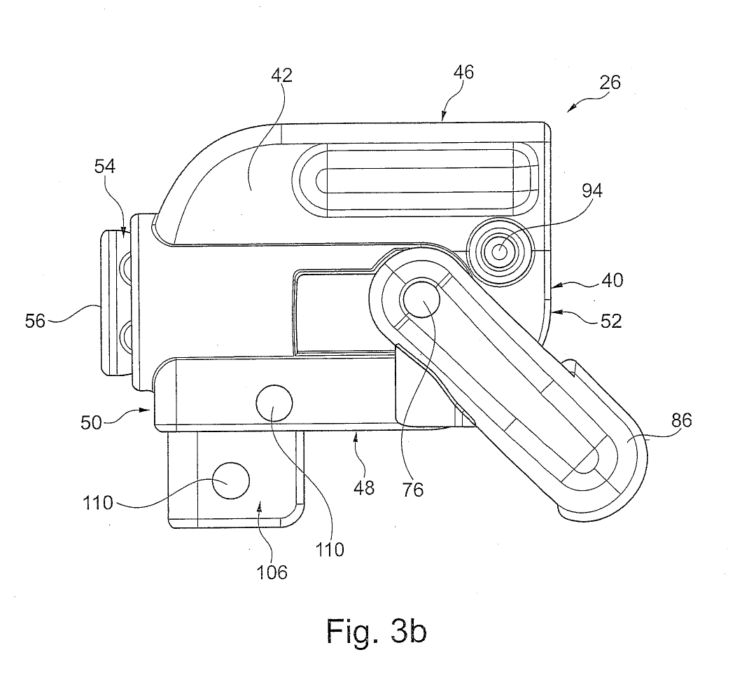

FIGS. 3a and 3b show securing means according to an embodiment of the present invention in an extended position and a retracted position respectively;

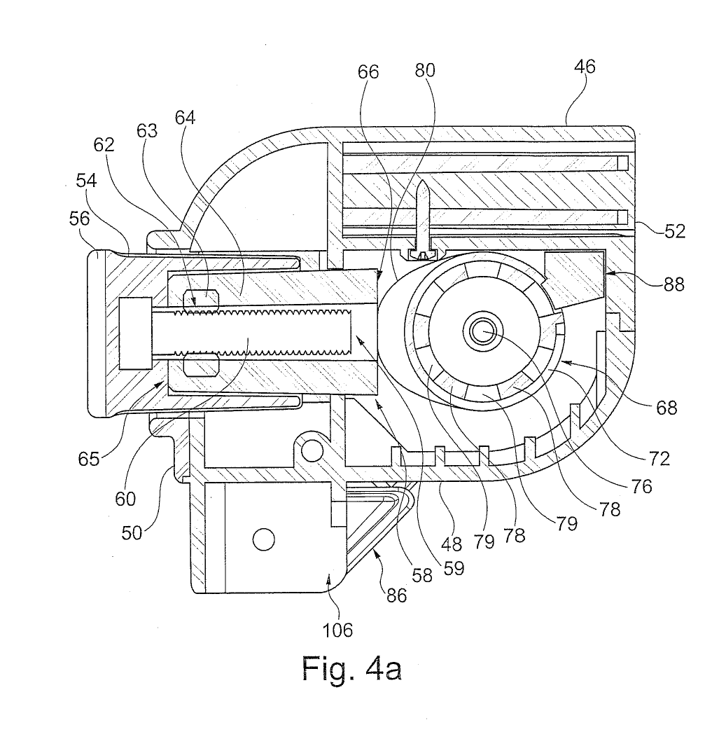

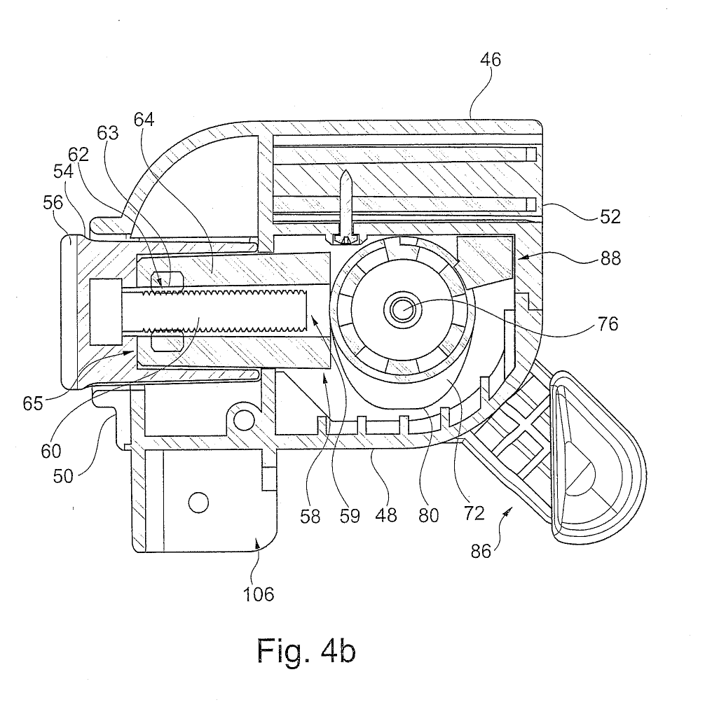

FIGS. 4a and 4b show a cross sectional view taken through the securing means in FIGS. 3a and 3b respectively; and

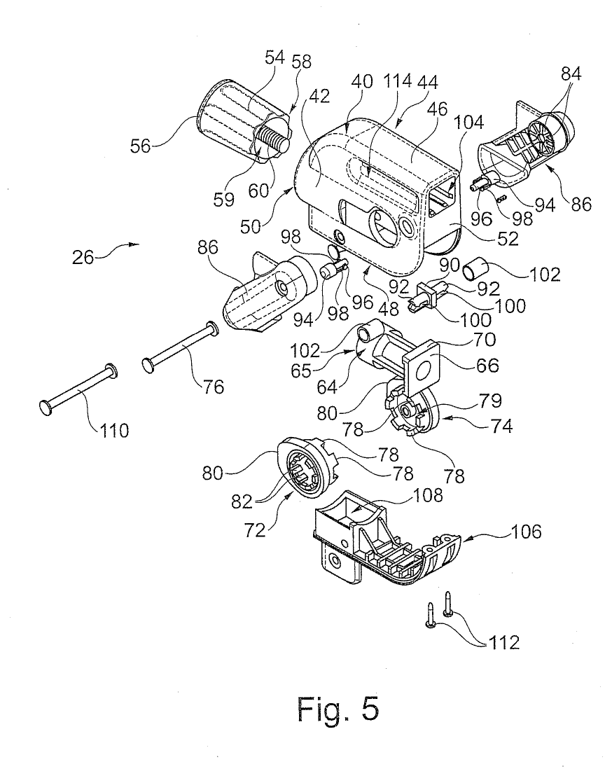

FIG. 5 shows an exploded view of the securing means in FIGS. 3a-4b.

Referring firstly to FIGS. 1a-2e, there is illustrated a barrier in the form of a foldable child safety gate 2 for location in an opening between at least two surfaces in use. The gate 2 can be located in the opening to form a closed position and can be removed from the opening to form an open position in use. With the gate 2 in a closed position, access through the opening is substantially prevented, particularly for a small child or animal. With the gate removed from the opening, the gate 2 is movable between an erect position, as shown in FIG. 1a, and a folded position, as shown in FIG. 1b.

Gate 2 includes a frame 4 having an upper horizontal frame member 6, a lower horizontal frame member 8 and lateral upright frame members 10, 12. Barrier means in the form of material 14 is provided over the frame 4 to prevent access from one side of the frame to the other side of the frame when the gate is in a closed position.

For clarity purposes, FIGS. 1b, 2d and 2e show the frame 4 with the barrier material 14 removed. It can be seen that the upper and lower frame members 6, 8 are adjustable in their length to allow adjustment of the width of the gate, thereby allowing the gate to be fitted in different sized openings in use. Thus, upper and lower frame members 6, 8 each include a smaller dimensioned frame member 6′, 8′ that is telescopically mounted in a slightly larger dimensioned frame member 6″, 8″ respectively. Engagement means 16 are provided to engage the frame members 6′,6″ and 8′, 8″ to a required length in use.

Lateral upright frame members 10, 12 also include two sub-frame members 10′, 10″ and 12′, 12″ that are pivotably joined via a pivot joint 18 respectively. A push button locking mechanism 20 is associated with the pivot joint 18 which, when actuated, allows the frame members 10′, 10″ and 12′, 12″ to be moved from an erect position to a folded position. As can be seen from FIG. 1b, in the folded position, the frame members 10, 12 are moved inwardly of the frame towards each other such that frame members 10′, 10″ are substantially adjacent to and parallel to each other and frame members 12′, 12″ are substantially adjacent to and parallel to each other. Upper and lower frame members 6, 8 are also substantially parallel to folded frame members 10′, 10″ and 12′, 12″ in the folded position.

Stopper means 22 are provided at the upper and lower corners of gate 2 on one edge 24 thereof, and securing means 26 according to the present invention are provided at upper and lower corners of gate 2 on an opposite edge 28 thereof, to allow engagement of the gate 2 to the surfaces defining the opening in which the gate is to be placed in use.

Each stopper means 22 includes a housing 30 having a first side 32 with a channel defined therein in which an end of upper frame member 6″ or lower frame member 8″ is located. A second opposite side 34 has a channel defined therein in which a stopper member 36 is movably or fixedly mounted. In the illustrated example, the stopper member 36 is rotatably mounted with the respect to housing 30 via a complementary screw thread arrangement. Rotation of the stopper member 36 allows some adjustment of the distance with which the stopper member can protrude from housing 30 to allow adjustment of the stopper member with respect to the surface with which it is to engage in use. A rubber gripping portion 38 is provided at the free end of stopper member 36 to increase the engagement of the stopper means 22 with the surface defining the opening in use.

Referring to FIGS. 3a-5, there is illustrated detailed views of the securing means 26 according to an embodiment of the present invention. The securing means 26 includes a housing 40 having a front surface 42, rear surface 44, top surface 46, base 48, first end 50 and second end 52. A stopper member 54 is provided which is movably mounted in a channel (not shown) defined in first end 50. In particular, stopper member 54 is movable from an extended position, as shown in FIGS. 3a and 4a, to a retracted position, as shown in FIGS. 3b and 4b. In the extended position, the stopper member 54 can be moved into engagement with a surface defining the opening in which gate 2 is to be located in use. In the retracted position, the stopper member 54 can be moved out of engagement with the surface defining the opening.

A rubber gripping portion 56 is provided at a first free end of stopper member 54 to increase the engagement of the stopper member 54 with the surface defining the opening in use. At a second end 58 opposite to the first free end there is provided a channel 59 with a screw thread 60 located substantially centrally thereof. The screw thread 60 is rotatably mounted to a complementary screw threaded portion 62 defined on a bolt 63 located in an inner housing 64. When assembled, an end 65 of the inner housing 64 is at least partly located in channel 59 of the stopper member 54. The complementary screw thread arrangement allows relatively fine adjustment of the position of protrusion of the free end of the stopper member 54 from the housing 40 to allow relatively fine adjustment of the engaging pressure of the stopper member 54 against the surface of the opening in which the gate is to be located in use. The inner housing 64 has a substantially flat or linear surface at an end 66 thereof to allow engagement with a cam surface there against in use, as will be explained in more detail below.

Cam means 68 are provided to slidably move the inner housing 64, and thus the stopper member 54 attached thereto, within the housing 40 between the extended and retracted positions. It is to be noted that the end 66 of inner housing 64 has a larger dimension or outwardly protruding flange 70 with respect to the remaining body of inner housing 64 to limit movement of the inner housing 64 in a forwardly direction towards first end 50 of housing 40. The end 58 of the stopper member 54 limits rearward movement of the inner housing and stopper member 54 in a rearwardly direction towards second end 52 of housing 40.

Cam means 68 include front and rear cam members 72, 74 which are pivotably mounted on a pivot pin or rivot 76. A plurality of spaced apart teeth members 78 are provided on opposing inner surfaces of cam members 72, 74 which protrude outwardly thereof such that the teeth members 78 and spaces 79 between the teeth members of each cam member 72, 74 inter-engage. As such, pivoting or rotation of cam members 72, 74 in use takes place substantially simultaneously. Cam members 72, 74 are substantially mirror images of each other.

A cam surface 80 is defined at one end of cam member 72, 74. Rotation or pivoting of the cam members 72, 74, moves the cam surface 80 into engagement with stopper member 54, as shown in FIG. 4a, and out of engagement with stopper member 54, as shown in FIG. 4b.

The outer surfaces of cam members 72, 74 are also provided with a plurality of outwardly protruding teeth members 82 which engage with complementary shaped apertures 84 defined on inner surfaces of user actuation means in the form of handles 86. Pivoting or rotation of handles 86 results in corresponding pivoting or rotation of cam members 72, 74. The handles 86 provided on the front and rear surfaces 42, 44 of housing 40 are substantially mirror images of each other and are arranged to allow actuation of the handles 86 from either side of gate 2. In the illustrated embodiment the handles 86 are in the form of substantially elongate arm members but any shape or design of handle could be provided as required.

Locking means 88 are associated with the cam members 72, 74 to lock the cam members in position corresponding to the retracted and extended positions of the stopper member 54.

More particularly, locking means 88 includes a locking member 90 which can be moved into engagement with the cam members 72, 74, thereby preventing rotation or pivoting of the cam members to form a locked position. Disengagement of the locking member 90 from the cam members 72, 74 allows rotation or pivoting of the cam members and forms an unlocked position.

Channel members 92 protrude outwardly on opposite sides of locking member 90 for receiving user actuation portions in the form of user actuation buttons 94. Thus, a user actuation button 94 is provided on both the front and rear surfaces 42, 44 of housing 40 to allow actuation of the locking means 88 from either side of gate 2.

User actuation button 94 includes an inwardly protruding arm portion 96 on which two outwardly protruding pins 98 are arranged on opposing surfaces and substantially transverse thereto. The arm portion 96 is located in the channel of channel members 92 and pins 98 protrude outwardly from two opposing slots 100 defined in the side walls of channel members 92. Resilient biasing means in the form of springs 102 are provided over the channel members 92 between the buttons 94 and the locking member 90 on each side of the locking member 90 and are held in place by the outwardly protruding pins 98. Springs 102 bias the locking member 90 to a locked position. The provision of two springs 102 providing a substantially similar biasing force in opposite directions towards each other ensures the locking means remain substantially central of the cam members. In order to move the locking member 90 to an unlocked position, a user is required to depress user actuation button or buttons 94 in a direction towards housing 40, thereby disengaging the locking member from cam members 72, 74 and allowing rotation of the cam members. As soon as the user releases button 94, the locking member 90 moves to a locked position with respect to the cam members 72, 74, thereby preventing further rotation of the cam members 72, 74 without further actuation of the user actuation button 94 being undertaken. Thus, it can be seen that in order to move the stopper member 54 between the extended and retracted positions, both the user actuation button 94 has to be depressed and the handle 86 then has to be rotated substantially simultaneously, as will be described in more detail below.

Attachment means are provided on housing 40 to allow attachment of the securing means to the upper frame member 6 and the upright frame member 10. More specifically, a recess 104 is defined in second end 52 of housing 40 to allow insertion of an end of upper frame member 6′ therein. The upper frame member 6′ can be secured by any suitable means, such as via one or more screws and/or the like. An attachment bracket 106 is attached to the base 48 of housing 40. A channel 108 is formed in the attachment bracket to allow insertion of an end of upright frame member 10′ therein. Attachment means in the form of rivets 110 can be used to attach the frame member 10′ to the bracket 106. The bracket 106 can be attached to the housing 40 via screws 112 and/or the like.

In fitting the gate 2 between first and second wall surfaces defining an opening therebetween, a user typically engages the stopper members 36 of stopper means 22 on side 24 of gate 2 against the first surface in a suitable position. The user then moves the opposite side 28 of gate 2 adjacent the second wall surface defining the opening. Operating each of two securing means 26 in turn, a user depresses lock button 94 to release the cam locking means 88 using one hand and, whilst gripping the handle 86 in their other hand, the user rotates handle 86 to allow rotation of the cam members 72, 74, thus moving the stopper means 54 between retracted and extended positions as required. Once the user has moved the stopper member 54 to a suitable position such that the free end of the stopper member engages against the second wall surface, the user can release the lock button 94. The spring 92 biases the locking member 90 to a locked position against the cam members 72, 74, thereby locking the cam members in the desired position.

Once a user has moved one of the securing means 26 into engagement with the wall surface, they can then actuate the other securing means, thereby securing the gate 2 in place between the two wall surfaces.

In the illustrations, it can be seen that with the handle 86 in a rearwardly position (i.e. with the free end of handle 86 facing towards end 52 of the housing 40 and away from the wall to which the securing means 26 is being engaged to), this corresponds to the stopper means being in a retracted position, as shown in FIG. 3b. In the retracted position, the stopper means 54 is located further within the housing 40 or protrudes outwardly of the housing 40 less relative to the stopper means when in the extended position. As the handle 86 is moved in a forwardly direction (i.e. the free end of handle 86 is moved towards end 50 of housing 40 and towards the wall to which the securing means 26 is being engaged to), this corresponds to the stopper means moving towards an extended position, as shown in FIG. 3a. In the extended position, more of the stopper means 54 protrudes outwardly of the housing 40 than with the stopper means in the retracted position.

A recess 114 can be defined on the front and/or rear surfaces 42, 44 of housing 40 to allow a user to grip the housing in use and to reduce the amount of material from which the housing is formed.

In the illustrations, the stopper means 22 are formed to be aesthetically similar in appearance to the securing means 26. Thus, the arrangement of the parts of stopper means 22 can be similar to securing means 26 but without the cam means 68, handles 86 or locking means 88 being present.

Although the securing means of the present invention has been shown on a foldable gate, it will be appreciated that the securing means could be used on a non-foldable gate. Any number of the securing means could be used in any suitable position on a gate as required.

Whilst the handles 86 of the upper securing means have been shown as being provided on a lower part of the housing and the handles of the lower securing means have been shown as being provided on an upper part of the housing, it will be appreciated that the securing means could be provided in any suitable orientation as required.

Although the securing means has been described with two handle portions, two locking portions and two cam portions, it will be appreciated that a single handle portion, locking portion or cam portion could be provided and would still allow operation of the securing means.

1. A securing means for use on a barrier, said securing means including a housing, stopper means that are movable relative to said housing between an extended position, wherein the stopper means protrude outwardly from said housing to allow engagement of the stopper means with a suitable surface in use, and a retracted position, wherein the stopper means is in a retracted position with respect to said housing relative to said extended position to allow disengagement of the stopper means from a suitable surface in use, and characterised in that cam means are provided and movement of said cam means results in movement of said stopper means between said extended and retracted positions.

2. A securing means according to claim 1 characterised in that the stopper means are rotatably, pivotably and/or slidably moved between the extended and retracted positions.

3. A securing means according to claim 2 characterised in that the stopper means are slidably moved in substantially horizontal direction between the extended and retracted positions in use.

4. A securing means according to claim 1 characterised in that the stopper means has gripping means or a gripping surface provided on or associated therewith to allow the stopper means to grip with a surface in which it engages with in the extended position in use.

5. A securing means according to claim 1 characterised in that the stopper means is in the form of an arm member movable relative to said housing between said extended and retracted positions.

6. A securing means according to claim 1 characterised in that the stopper means includes a stopper element and a stopper housing and the stopper element is movable relative to said stopper housing.

7. A securing means according to claim 6 characterised in that the movement of the stopper element is independent to the movement of the stopper means as a result of movement of the cam means.

8. A securing means according to claim 6 characterised in that the stopper element is rotatably mounted to the stopper housing.

9. A securing means according to claim 1 characterised in that the cam means are movably mounted in or on said housing and can be rotatably, pivotably or slidably movable to allow movement of said stopper means between said extended and retracted positions.

10. A securing means according to claim 9 wherein user actuation means are provided on or associated with said housing and/or said cam means and movement or actuation of said user actuation means allows movement of the cam means in use.

11. A securing means according to claim 10 characterised in that the user actuation means and/or handle means are provided on two or opposite sides of the housing to allow the same to be actuated from different sides of the housing and/or barrier on which the housing is mounted in use.

12. A securing means according to claim 1 characterised in that the cam means includes a cam surface which is moved between engaged and disengaged positions with respect to the stopper means in use and the stopper means includes a substantially flat or linear surface against which the cam means or cam surface moves in and out of engagement with in use.

13. A securing means according to claim 1 characterised in that locking means are provided to lock the cam means in the engaged and/or disengaged positions and wherein resilient biasing means are provided to bias the locking means to a locked position with respect to the cam means in use.

14. A securing means according to claim 13 characterised in that the locking means includes one or more user actuation portions to allow a user to actuate the locking means and wherein the user actuation portion of the locking means has to be actuated substantially simultaneously to actuation of the user actuation means associated with the cam means in use.

15. A securing means according to claim 14 characterised in that the user actuation portion of the locking means is accessible from or provided on two or more sides or opposite sides of the housing to allow actuation of the locking means from two or more sides or opposite sides of the barrier on which the securing means is mounted in use.

16. A securing means according to claim 15 characterised in that the locking means includes a locking member and the locking member is resiliently biased to an engaged position against the cam means to substantially prevent movement of the cam means when the locking means is in the locked position.

17. A barrier including a securing means according to claim 1.

18. A method of operating a securing means according to claim 1 characterised in that said method includes the steps of moving a stopper means between the extended and retracted positions.
